(19) United States
(12) Patent Application Publication
(10) Pub. No.: US 2009/0108976 A1
(43) Pub. Date: Apr. 30, 2009

(54) TRANSFORMER BOBBIN WITH ISOLATION WIND

(75) Inventors: Louis R. Nerone, Brecksville, OH (US); Gordon Alexander Grigor, Cleveland Heights, OH (US)

Correspondence Address: Fay Sharpe LLP, 1228 Euclid Avenue, 5th Floor, The Halle Building, Cleveland, OH, 44115, US

(73) Assignee: GENERAL ELECTRIC COMPANY

(21) Appl. No.: 11/931,753

(22) Filed: Oct. 31, 2007

(51) Int. Cl. H01F 27/29; H01F 27/30; H01F 41/06

(52) U.S. Cl. 336/192; 336/198; 29/605

(57) ABSTRACT

A transformer bobbin has a body with first and second ends spaced along a longitudinal axis. Conductive pins are mounted in the ends and dimensioned for electrical and mechanical connection with first and second wire windings received in the body. An opening in the body is dimensioned to receive a ferrous core, and an external winding surface on the body extends between the first and second ends. First and second margin barriers are provided inwardly of the first and second ends of the winding surface. The margin barriers have a height that extends a predetermined dimension that closely approximates the height of the first winding. The margin barriers electrically isolate the first winding from the second winding that is thereafter received over the body. Preferably, at least one of the first and second margin barriers includes channels therethrough dimensioned to receive the first winding wire for connection with the pins.

### BACKGROUND OF THE INVENTION

This disclosure is directed to a transformer assembly of the type that employs a bobbin surrounding a core and over which multiple windings are provided on the bobbin. More particularly, the disclosure is directed to a new bobbin arrangement used in the transformer assembly that improves the electrical isolation of one winding relative to another winding. Although this arrangement finds particular application for use in a transformer associated with a driving circuit and ballast associated with a lighting assembly, it will be appreciated that it may find application in related environments outside of the lighting field.

Known transformer constructions, including those used in association with lighting applications, often employ a ferrous core received in the bobbin. The bobbin is typically formed from a plastic material such as a PET material. Multiple wire windings are received around the bobbin, and opposite, terminal ends of the windings are electrically and mechanically connected to posts and pins that extend outwardly from one or more ends of the bobbin. Each pin is then adapted for receipt in a printed circuit board. Depending on how an operating circuit is laid out on the board determines how the pins, and likewise how the windings, are integrated into the circuit.

It is important to be able to electrically isolate one winding from another winding on the bobbin. Thus, a first wire winding is normally physically and electrically isolated from another winding by use of an insulating material. A common type of insulating material is an insulating tape that is helically wound in one or more layers over a completed wire winding. That is, once a first winding is complete, the outer surface or perimeter is covered with a winding of insulating tape. Thereafter, the next winding or second wire winding is received over the insulating tape. It will be appreciated, that more than one layer of tape, and likewise more than one layer of wire windings may be used as particularly needed for the circuit, and for the desired insulating properties.

To constrain the wires of each winding, opposite ends of the bobbin include end members or end walls. The end walls extend substantially perpendicular to an outer perimeter of the centrally disposed winding surface of the bobbin. Slots or recesses are usually provided in the end walls of the bobbin to allow each end of a particular winding to extend therethrough for connection with a respective pin.

As will be appreciated by one skilled in the lamp art, it is important to electrically isolate one winding from the other. In one particular exemplary application, the first winding may be used for dimming purposes. It becomes necessary for the windings to withstand a UL 935 test, which is one example of a test that subjects the bobbin with the windings to 2500 volts AC for sixty (60) seconds without any breakdown or shorting of the wire windings or on the circuit board traces. It has been found that prior assemblies that have failed the test or a similar test often exhibit breakdown issues or shorting at one end of the first winding since the separate windings or wire layers are potentially exposed at these ends. Thus, there is a need to further isolate the first winding from the second winding and more importantly to address the breakdown/shorting issue. Even though insulating tape is provided over each winding in an effort to isolate one winding from another winding, there is still the potential for creepage or breakdown between the windings.

In a high production environment, it is particularly important to provide increased product reliability that not only can achieve the desired electrical isolation requirements, but also do so in a manner where the solution can be incorporated into manufacturing or assembly in a repeatable, effective manner. Thus, a solution that is conducive to manufacturing or commercialization considerations is most desirable.

### SUMMARY OF THE INVENTION

A bobbin used in an associated transformer assembly of an electrical power supply includes a body having first and second ends spaced along a longitudinal axis. At least a pair of conductive pins are dimensioned for electrical and mechanical connection with associated wire windings which are received on the bobbin body. An opening extends longitudinally through the bobbin to receive a ferrous core therein. An external surface of the bobbin body extends between the first and second ends and forms a winding surface that is laterally offset or radially spaced from the longitudinal axis and surrounds the core opening. First and second margin barriers are provided at first and second ends of the winding surface. The margin barriers have a lateral or radial height extending above the winding surface a predetermined dimension that closely approximates the height of an associated first winding received on the winding surface whereby the margin barriers electrically isolate the associated first winding from associated additional windings to be received on the body and also axially constrain the first winding therebetween.

The first margin barrier includes first and second channels extending therethrough for receipt of the associated first winding. The channels preferably include angled entrances to facilitate entrance or exit of one end of the first winding wire through the margin barrier and also have a width that is at least as great as an associated diameter of the first winding wire. The first and second ends have a lateral or radial height substantially greater than that of the margin barriers in order to axially contain the additional windings.

A transformer assembly incorporates the preferred bobbin arrangement. The bobbin body opening receives a ferrous core, and has an external winding surface extending between the first and second ends surrounding the core. First and second margin barriers extend outwardly from the winding surface a height that approximates the height of the associated first winding. The margin barriers electrically isolate the first winding from the second winding received thereover on the body.

The bobbin in one embodiment has a varying wall thickness defined between the core and the winding surface as the wall proceeds about the core.

A method of winding a first wire on the bobbin winding surface includes providing margin barriers adjacent the end walls, and winding the first wire between the first and second margin barriers. An insulating material is subsequently placed over the first wire winding and the margin barriers, preferably wrapping an insulating tape at the same perimeter dimension over an outer surface of the first wire winding and the margin barriers.

The margin barriers provide a more reliable electrical isolation between the first and second windings.

Providing slots through the margin barriers advantageously allow for an uninterrupted path for the wire leads to the pins while maintaining electrical isolation between the windings.

Still other benefits and advantages of the present disclosure will become apparent from reading and understanding the following detailed description.

### BRIEF DESCRIPTION OF THE DRAWINGS

FIG. 1 is an elevational view of the subject new bobbin.

FIG. 2 is a bottom plan view thereof.

FIG. 3 is an end view of the bobbin taken generally from the right-hand end of FIG. 1.

FIG. 4 is a cross-sectional view of the bobbin taken generally along the lines 4-4 of FIG. 1.

FIG. 5 is a cross-sectional view of the bobbin taken generally along the lines 5-5 of FIG. 1.

FIG. 6 is an enlarged view of the encircled area of FIG. 2.

FIG. 7 is a schematic representation of the winding geometry of the transformer.

FIGS. 8 and 9 are plan and end views, respectively, of a preferred core.

### DETAILED DESCRIPTION

As noted in the Background, the present disclosure is directed to a transformer assembly and particularly a new bobbin design therefore. Although it finds particular application in association with a transformer incorporated into electronics for driving a lamp, one skilled in the art will recognize that it need not be limited to this particular application.

A bobbin 100 includes a body 102 that has an opening or recess 104 extending through the body so that the bobbin body has a generally hollow conformation. First and second ends 106, 108 are spaced from one another along a longitudinal axis 110, and form end members or end walls 112, 114, respectively. The end walls are generally perpendicular or orthogonal to the longitudinal axis and define the axial extent of the additional windings other than the first winding, i.e., axially confine the additional windings, as will be described further below.

Generally centrally disposed between the end walls, and at a reduced dimension from the longitudinal axis is a winding surface 120. Winding surface 120 is generally rectangular in cross-section as best seen in FIG. 4. Preferably the winding surface 120 has the same perimeter dimension along its axial extent. Rather than the winding surface merging directly into the end walls 112, 114, margin barriers 122, 124 are axially interposed between the winding surface 120 and the end walls 112, 114. The margin barriers are preferably formed from the same material and integrally or formed from the same material as the remainder of the bobbin. More particularly, the margin barriers 122, 124 have a height that is substantially equal to the height of the first winding. In a first preferred embodiment, the first wire winding is comprised of two layers. Therefore, the total height of the margin barrier above the winding surface 120 is equal to twice the diameter of the first winding wire.

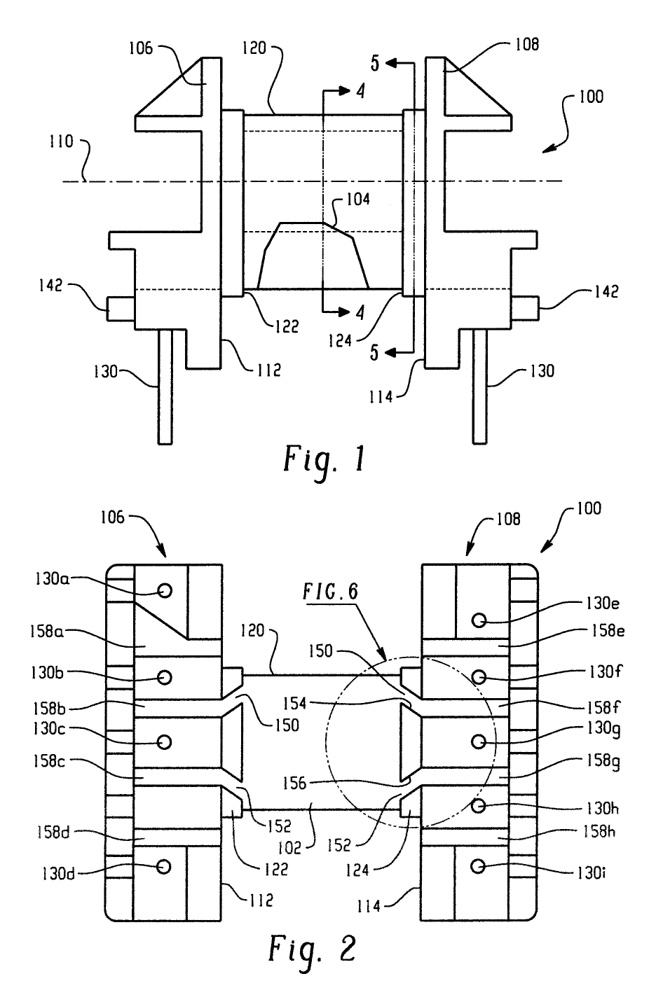

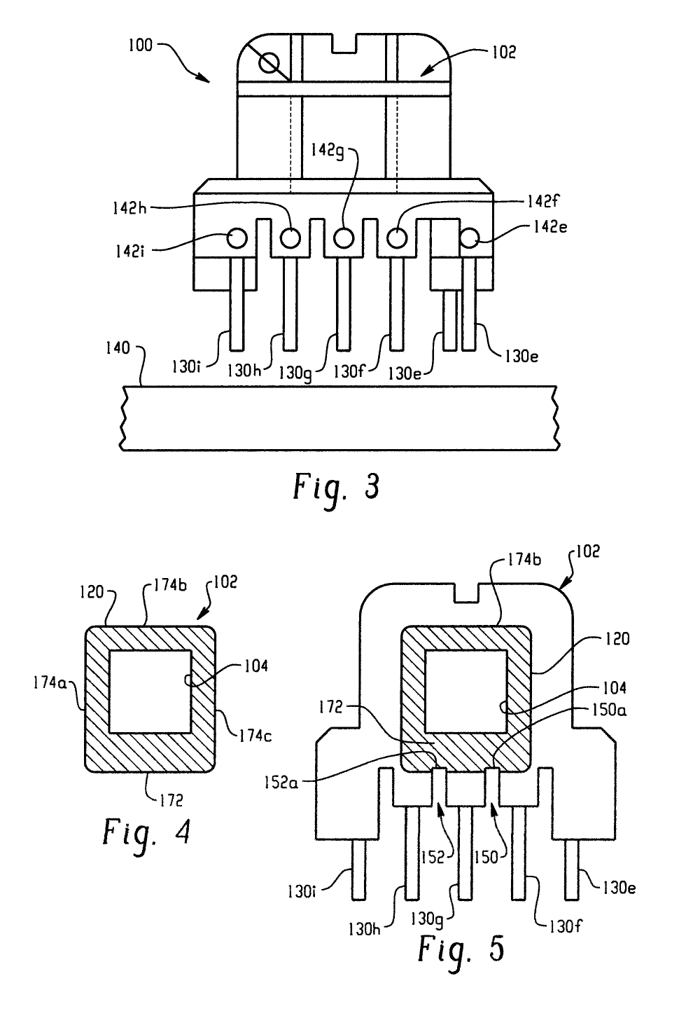

With continued reference to FIG. 1, and additional reference to FIGS. 2 and 3, it will be further evident that there are multiple pins 130a-i that extend outwardly from the bobbin. As perhaps best evident in FIGS. 1 and 3, the pins have an elongated length in a direction generally perpendicular to that of the longitudinal axis 110 and so are adapted for receipt through respective openings (not shown) in printed circuit board 140 (FIG. 3). Moreover, there is a post 142 associated with each pin 130 and each post extends outwardly from the bobbin in the axial direction, i.e., generally parallel to the longitudinal axis 110. Each post 142 (142a-142i) formed from the same material as the bobbin body, i.e., integrally formed as a part of the bobbin body, permits the lead end of a wire to be mechanically wrapped about the post as the lead end proceed to electrical and mechanical connection between the end of a wire winding and one of the pins.

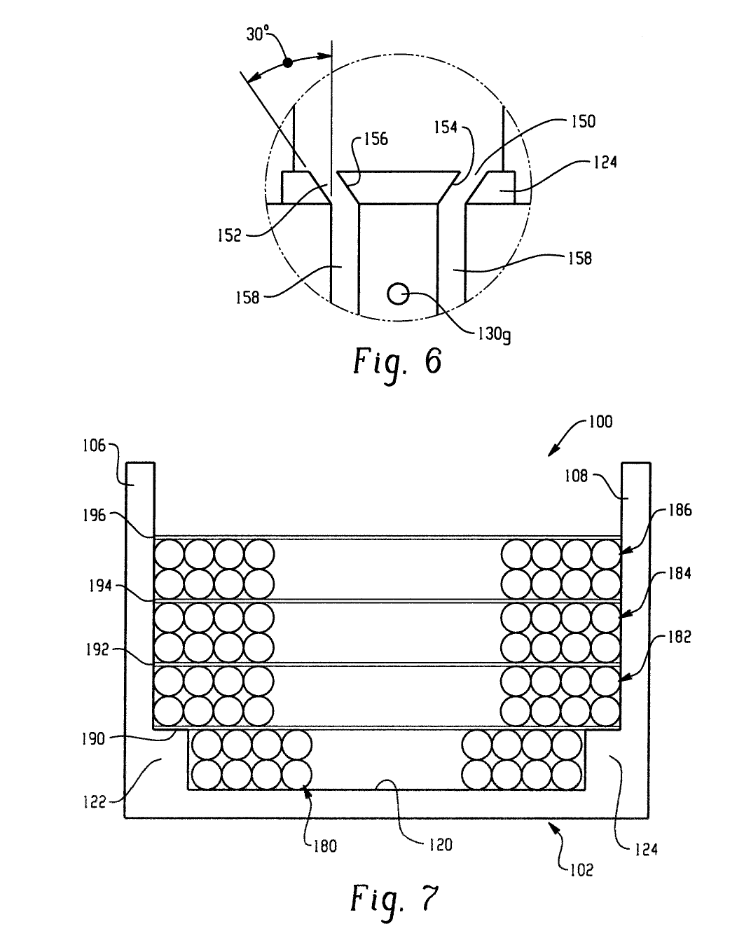

With more particular emphasis on FIGS. 2, 5, and 6, it is evident that the margin barriers each include first and second slots or channels 150, 152. The base 150a, 152a of each slot in the margin barrier extends slightly below the remainder of the winding surface (compare FIGS. 4 and 5) so that once the first winding wire is inserted therein and passes therethrough for wrapping around the respective posts 142 and mechanical and electrical connection with an associated pin 130, a smooth transition is provided between the outer perimeter of the first winding and the outer perimeter surface of the margin barriers. The extent (i.e., depth) of these channel recesses is evident in FIG. 5. In this manner, the leads extend to and from the winding through the bottom of the grooves in the margin barrier, and do not raise the height of the windings adjacent the ends above the height of the margin barrier. It will also be appreciated that the channels 150, 152 preferably have an angular conformation 154, 156 at one end, i.e., they extend at an angle greater than zero degrees (0°) and less than ninety degrees (90°) measured relative to the longitudinal axis. A more preferred range is approximately thirty degrees (30°), although that angle may vary as necessary. Again, the angular conformation 154, 156 provides for ease of transition of the wire lead between the terminated coil portion or winding of the wire about the bobbin winding surface 120 and the passage of the wire lead through the margin barrier 122, 124 for connection with a particular pin 130. In addition, one or more of passages 158 (e.g., 150 a in FIG. 2) through the end walls may be enlarged or angled to further segregate or space the wire leads from an adjacent wire lead as the leads are wrapped around the post and terminated at the associated pin. It will also be appreciated that two of these passages 158 through each end wall are aligned with the channels 150, 152 through the margin barriers as evident in FIG. 6.

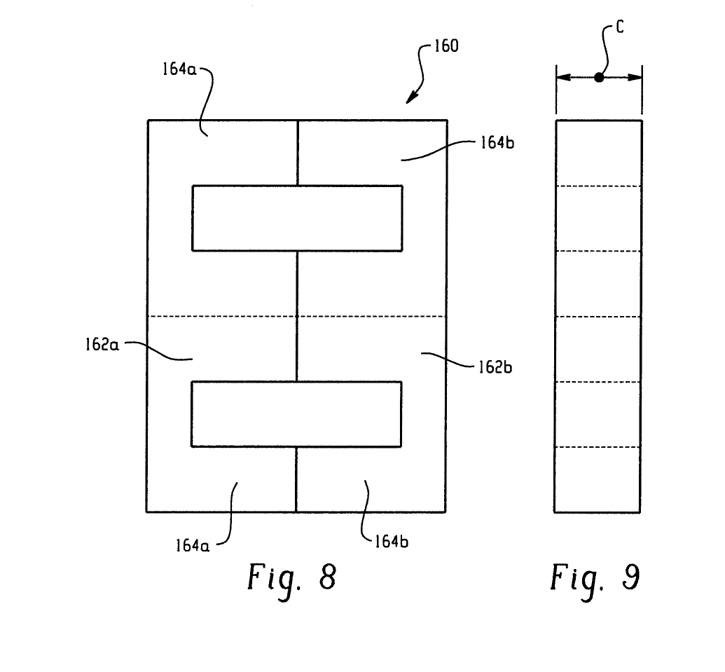

As is also particularly illustrated in FIGS. 4 and 5, the recess or opening 104 has a generally rectangular conformation. As will be understood, the ferrous core 160 (FIGS. 8 and 9) is similarly configured to have a generally rectangular outer perimeter conformation. The core is a conventional structure often referred to as an EE core where the configuration resembles a pair of capital E's in facing relation. Since the core does not form any particular aspect of the present invention, and is well known to one skilled in the art, further discussion herein is deemed unnecessary. The ferrous core shown in FIGS. 8 and 9 is a generally conventional core referred to as a EE core where the general configuration of the core is first and second facing capital “E”s. A middle leg 162a (162b) of each core portion 160 is dimensioned for receipt through a respective end of the passage 104 through the bobbin while outer legs 164a (164b), 166a (166 b) of each core portion are received outside of the bobbin in a manner known in the art. The wall thickness of the bobbin around the core also varies as is evident from FIGS. 1, 4, and 5. More particularly, one of the walls, namely what is referenced as a bottom wall 172, has a greater thickness than the remaining bobbin walls 174.

With continued reference to FIGS. 1-6, and additional reference to FIG. 7, the impact of the margin barriers will be more fully illustrated and described. That is, the axial extent of first winding 180 is less than the axial extent of each of the second, third, and fourth windings 172, 174, 176, respectively, because of the axial constraint provided by the margin barriers 122, 124. The first wire winding 180 is comprised of two layers in the preferred arrangement. For example, the first winding 180 includes forty (40) turns per layer to achieve a total of eighty (80) turns. Of course, a different number of turns per layer and consequently total number of turns can be used without departing from the present disclosure. Nevertheless, it is intended that the first winding 180 extend over the winding surface 120 but is axially constrained between the margin barriers 122, 124. With the height of first winding 180 corresponding to the height of the margin barriers 122, 124, a first insulating tape 190 is continuously placed at a same dimension over the second layer of the first winding 180 and over the outer perimeter of the margin barriers 122, 124. The first insulating tape 190 forms a substantially planar insulating barrier along its axial length as perhaps best illustrated in FIG. 7. The margin barriers, as well as the insulating tape, provide for suitable additional isolation of the first winding from the overlying second winding 182, etc. The margin barriers allow isolation of this first winding from the remaining windings 182, 184, 186 and further prevent creepage along the edge (adjacent the end members 106, 108) which heretofore has resulted in breakdown between the second winding 182 disposed on top of the first winding 180. That is, in the past, the transformer assembly would be prone to short between the first and second windings 180, 182 along the edge because of creepage. Here, however, the bobbin margins 122, 124 provide for additional isolation, and further assure that there is no variation in the first insulating tape 190 received over the first winding.

In a similar manner, the second winding layer 182 is wrapped in two layers over the first insulating tape. In one preferred arrangement, the second wire winding is comprised of fifty (50) turns in the first layer and only ten (10) turns in the second layer (60 turns total). It will be appreciated that FIG. 7 illustrates only portions of each winding and would appear to illustrate the same number of turns in each winding layer. However, the number of turns in each layer may vary, and thus the pitch of the turns may vary from one layer to another. Alternatively, if the second layer has less turns than the first layer, the turns of the second layer may be evenly spaced over the axial length between the end walls, or it is contemplated that the turns of the second layer may be grouped at one location along the axial length between the end walls.

As is evident in FIG. 7, since the second wire can proceed over the margin barriers provided at the ends there is a greater axial length of winding which permits a greater number of turns per layer. Moreover, the axial extent of the second winding is axially constrained by the end walls 112, 114. Thus, the second winding preferably has a total of sixty (60) turns. Thereafter, an insulating material such as a second insulating tape 192 is wrapped over the second winding layer, and similarly, the third wire winding 184 proceeds over the second insulating tape 192 and between the end walls 106, 108 and is thereafter surrounded by a third insulating tape 194. Likewise, a fourth wire winding 186 is provided on top of the third insulating tape 194 and between the end walls 112, 114. Last, a fourth insulating material or insulating tape 196 is wrapped about the outer perimeter of the fourth winding. In the particular embodiment, the third and fourth windings are each comprised of sixty (60) total turns, fifty (50) turns in the first layer and ten (10) turns in the second layer. However, these numbers of turns at each layer, and the total number of turns may be varied as may be required for different applications without departing from the scope and intent of the present disclosure.

In the particular lighting application, the first winding 180 may be part of a dimming circuit and thus must be able to withstand a large voltage of AC for an extended period of time and be suitably isolated from the second winding 182 received thereover. As will also be appreciated, the winding surface 120 also has a generally rectangular conformation because of the shape or configuration of the bobbin. The margin barriers 122, 124 advantageously allow isolation of the edge of the first winding 180 from the remaining windings of the transformer. The margin barriers eliminate creepage and two channels are preferably provided in each margin barrier to receive the wire of the first winding therethrough. In this manner, a first end of the first wire is secured to a pin, then proceeds through a first channel 150 (FIG. 2) where it is then wound on the winding surface from the first margin barrier 122 to the second margin barrier 124 to define a first layer. Thereafter, the second layer of the first wire winding is wrapped around the first layer and extends back toward the first margin barrier. Once the wire reaches the margin barrier where it started, the wire lead is directed through the second slot 152 in the margin barrier, through a passage 158 in the end wall, and thereafter terminates (i.e., electrically and mechanically connects) on a different pin.

In the particular illustrated example, two layers of tape are provided over the first winding, although more or less layers of tape may be used if the desired insulative effect is to be varied. The tape proceeds over the first winding and also over the margin barriers to provide a flat surface to receive the next winding. The tape discourages breakdown, and is preferably continuous over its length. In a similar manner, the second, third and fourth wire windings are interleaved with insulating tape. One difference is that only a single layer of insulating tape is required for the additional windings, since these are lower voltages, and thus the concern with breakdown and creepage is not as evident.

Once the windings and tape wrappings are complete and the core has been assembled to the bobbin, the entire assembly is vacuum impregnated with varnish. This is a conventional manner of completing the assembly. That is the bobbin with accompanying windings and tape is dipped into a reservoir of varnish and then placed in a vacuum chamber. The assembly is baked in an oven at a temperature, for example, on the order of 120° C. for an extended period of time, for example, approximately four (4) hours.

Although it may be possible to use a sectional bobbin where the end barriers are provided in the middle and then each winding is placed in its own pocket, the desired electrical coupling from one winding to the next winding would be lost. Thus, there is no desire to isolate the windings in their own pockets in the bobbin, but rather it is more desirable to have one winding on top of another to improve the electrical coupling therebetween. The slots 150, 152 in the margin barriers also attend to the creepage issue or electrical isolation, while the slots provide the desired need to draw the wire into the bottom of the slotted channel so that the first insulating tape can remain at the same perimeter dimension. Slots are preferably provided through each margin barrier. Although in the particular example, the first wire is terminated at its first and second ends at the same end of the bobbin, providing the slots through each margin barrier provides for greater versatility to other uses.

In summary, inclusion of margin barriers 122, 124 built into the bobbin provide for the desired end isolation of the first winding 180 from the second winding 182. Providing slots 150, 152 through these margin barriers then allows for an uninterrupted path for the wire to pass therethrough and further enhances electrical isolation.

The invention has been described with reference to the preferred embodiments. Obviously, modifications and alterations will occur to others upon reading and understanding the preceding detailed description. It is intended that the invention be construed as including all such modifications and alterations.

What is claimed is:

1. A bobbin for use in a transformer comprising:
a body having first and second ends spaced from one another along a longitudinal axis, at least one of the first and second ends including at least a pair of conductive pins dimensioned for electrical and mechanical connection with associated wire windings received on the body, an opening extending longitudinally inwardly through the body for receiving an associated core therein, and an external surface of the body extending between the first and second ends forming a winding surface that is radially spaced from the longitudinal axis and surrounding the opening; and
first and second margin barriers at first and second ends of the winding surface, the margin barrier having a radial height that extends above the winding surface a predetermined dimension that closely approximates the radial height of an associated first winding to be received on the winding surface whereby the margin barriers axially constrains the first winding to enhance electrical isolation between the first winding and additional windings received on the body.

2. The bobbin of claim 1 wherein at least the first margin barrier includes first and second channels extending therethrough for receipt of a lead of the associated first winding.

3. The bobbin of claim 2 wherein the channels include angled entrances to facilitate entrance or exit of the associated first winding wire through the margin barrier between the winding surface and the pins.

4. The bobbin of claim 2 wherein the channels have a width that closely approximates an associated diameter of the associated first winding wire.

5. The bobbin of claim 2 wherein the first and second ends have a radial height substantially greater than the margin barriers, and at least the first end includes at least first and second axial passages that communicate with the first and second channels, respectively.

6. The bobbin of claim 5 wherein the winding surface has a generally rectangular cross-sectional conformation.

7. The bobbin of claim 5 wherein the opening has a generally rectangular cross-sectional conformation.

8. The bobbin of claim 1 wherein the first and second margin barriers include first and second channels extending therethrough for receipt of a lead of the associated first winding.

9. The bobbin of claim 8 wherein the first and second ends have a radial height substantially greater than the margin barriers, and each end includes at least first and second axial passages that communicate with the first and second channels, respectively.

10. The bobbin of claim 8 wherein the channels include angled entrances to facilitate entrance or exit of the associated first winding wire through the margin barrier between the winding surface and the pins.

11. The bobbin of claim 10 wherein the angle is greater than zero degrees and less than ninety degrees.

12. A transformer assembly comprising:
a bobbin body having first and second ends spaced from one another along a longitudinal axis, conductive pins mounted in the ends and dimensioned for electrical and mechanical connection with at least first and second wire windings received on the body, an opening in the body dimensioned to receive a ferrous core therein, and an external winding surface on the body extending between the first and second ends surrounding the core; and
first and second margin barriers at first and second ends of the winding surface adjacent the ends and having a height that extends a predetermined dimension that closely approximates the height of an associated first winding to be received on the winding surface whereby the margin barriers electrically isolate the first winding from the second winding received thereover on the body, at least one of the first and second margin barriers including channels therethrough dimensioned to receive the first winding wire therethrough.

13. The transformer assembly of claim 12 wherein the first and second ends include first and second passages that communicate with the first and second channels, respectively, for receipt of opposite ends, respectively, of the first winding therethrough.

14. The transformer assembly of claim 12 wherein the margin barriers each have a height equal to twice the diameter of the first winding wire.

15. The transformer assembly of claim 12 wherein the channels through the margin barriers are disposed at an angle greater than zero degrees and less than ninety degrees relative to the longitudinal axis.

16. The transformer assembly of claim 12 wherein the winding surface has a generally rectangular cross-sectional conformation.

17. The transformer assembly of claim 12 wherein the bobbin has an asymmetrical wall thickness defined between the core and the winding surface.

18. A method of forming a transformer comprising:
providing a bobbin having first and second end walls at opposite ends of a winding surface,
providing margin barriers adjacent the end walls;
winding a first wire on the bobbin winding surface between the first and second margin barriers;
placing an insulating material over the first wire winding and margin barriers; and
winding a second wire between the end walls over the first wire winding and insulating material.

19. The method of claim 18 further including providing channels through the margin barriers dimensioned to receive the first wire winding therethrough.

20. The method of claim 18 wherein the insulating placing step includes wrapping an insulating tape at the same perimeter dimension over an outer surface of the first wire winding and the margin barriers.
